(19) United States
(12) Patent Application Publication
(10) Pub. No.: US 2025/0314804 A1
(43) Pub. Date: Oct. 9, 2025

(54) MEASUREMENT METHOD, MEASUREMENT SYSTEM, AND INFORMATION PROCESSING APPARATUS

(71) Applicant: Nippon Telegraph and Telephone Corporation, Tokyo (JP)

(72) Inventors: Tatsuya IIZUKA, Musashino-shi, Tokyo (JP); Toru NAKAMURA, Musashino-shi, Tokyo (JP); Naoko KOSAKA, Musashino-shi, Tokyo (JP); Yusuke UMEMIYA, Musashino-shi, Tokyo (JP); Masaki HISADA, Musashino-shi, Tokyo (JP)

(21) Appl. No.: 18/865,718

(22) PCT Filed: May 26, 2022
(86) PCT No.: PCT/JP2022/021547

§ 371 Date: Nov. 14, 2024

(51) Int. Cl. G01W 1/08; G01K 1/20; G01W 1/18

(52) U.S. Cl. CPC G01W 1/08; G01W 1/18; G01K 1/20

(57) ABSTRACT

A drone equipped with a sensor obtains a measured value y₁(t) while moving at a velocity v₁, and the drone obtains a measured value y₂(t) while moving at a velocity v₂ different from the velocity v₁. An information processing device derives a time constant τ of the sensor for correcting the measured value of the sensor using the measured values y₁(t) and y₂(t) and the velocities v₁ and v₂ for a transfer function of the sensor.

### TECHNICAL FIELD

The present invention relates to a measurement method, a measurement system, and an information processing device.

### BACKGROUND ART

In order to predict extreme weather, there is an increasing demand for a technique for measuring a specific region with high accuracy and high frequency. For example, it has been clarified that, in linear precipitation zones, inflow of warm and moist air continues at a low altitude of about 1 km or less, clouds are formed when the air is lifted by the influence of fronts and topography, cumulonimbus clouds develop in unstable atmospheric conditions, and strong winds in the sky cause the cumulonimbus clouds to move downwind and line up in a line. Highly accurate measurements of a vertical distribution of atmospheric temperature and humidity up to 1 km altitude are considered important for predicting linear precipitation zones.

Until now, highly accurate weather measurements of the vertical distribution of the atmosphere have been carried out using radiosondes. However, due to the nature of measurements using radiosondes, which involve releasing rising balloons, there are the following problems in improving the accuracy of extreme weather predictions. First, there is a problem that it is difficult to increase the number of times that unmanned measurements can be repeated, due to the necessity of injecting gas into the radiosonde balloon and the rapid rate of gas consumption. Second, there is a problem that radiosondes are difficult to measure accurately at a desired position because they are swept up by the wind after being released and their position cannot be controlled.

In recent years, as drones have become more sophisticated and cost-effective, there has been an increase in the number of cases in which drones are equipped with measuring instruments and control the position of the measuring instruments to perform highly accurate weather measurements at precise positions (Non Patent Literature 1).

### CITATION LIST

### Non Patent Literature

Non Patent Literature 1: Hiroki Nishihara and two others, “Observation of Meteorological Information of Fog in Vertical by using Drone Technology”, Journal of Environmental Information Science, 2020, Vol. 34, pp. 228-233

### SUMMARY OF INVENTION

### Technical Problem

Weather measurements using drones require long-term use and operation. For this reason, weather measurement sensors mounted on drones are required to have high durability, and their time response tends to be slow.

There is a desire to obtain the vertical distribution of the atmosphere with high accuracy and high simultaneity. In order to increase simultaneity, it is necessary to increase the moving velocity of the drone. If the moving velocity of the drone is increased, the error in the measured value will increase due to the influence of the response speed of the sensor. For this reason, there is a problem in that it is difficult to achieve both measurement accuracy and simultaneity. FIG. 1(a) illustrates the temperature measured by raising the drone from the ground to the sky and the actual temperature, and FIG. 1(b) illustrates the relationship between the ascent velocity of the drone and the measurement error at the maximum altitude. As illustrated in FIG. 1(a), the higher the altitude, the larger the error, and as illustrated in FIG. 1(b), the higher the velocity, the larger the error.

If the response speed of the sensor is accurately obtained, the actual distribution can be calculated backwards from the measured values, but there are cases where a time constant of the sensor is unknown. Even if a time constant is stated in the specification sheet, there may be variations between sensors and individual differences. There are many situations in which the response time during mobile measurements is not accurately known. Therefore, there is a problem in that the actual distribution cannot be calculated backwards from the measured values, making it impossible to perform highly accurate measurements.

The present invention has been made in view of the above, and an object of the present invention is to obtain unknown characteristics of a sensor.

### Solution to Problem

A measurement method according to one aspect of the present invention is a measurement method using a moving object equipped with a sensor, the measurement method including: a step of obtaining a first measured value while the moving object is moving at a first velocity; a step of obtaining a second measured value while the moving object is moving at a second velocity different from the first velocity; and a step of deriving a time constant of the sensor for correcting the measured value of the sensor using the first measured value, the second measured value, the first velocity, and the second velocity for a transfer function of the sensor.

A measurement system according to an aspect of the present invention is a measurement system including: a moving object equipped with a sensor; and an information processing device that derives a time constant of the sensor, in which the moving object obtains a first measured value while moving at a first velocity, and obtains a second measured value while moving at a second velocity different from the first velocity, and the information processing device includes: an input unit to which the first measured value, the second measured value, the first velocity, and the second velocity are input; and a calculation unit that derives a time constant of the sensor for correcting the measured value of the sensor using the first measured value, the second measured value, the first velocity, and the second velocity for a transfer function of the sensor.

### Advantageous Effects of Invention

According to the present invention, unknown characteristics of a sensor can be obtained.

### BRIEF DESCRIPTION OF DRAWINGS

FIG. 1 is a diagram illustrating an example of a measurement error.

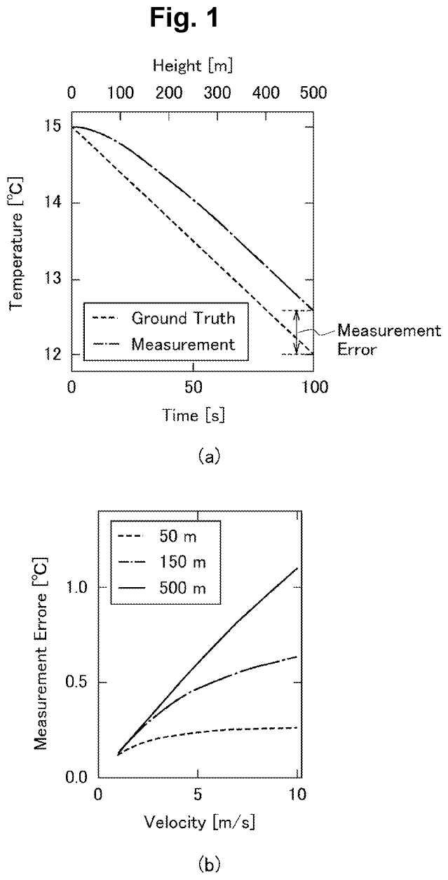

FIG. 2 is a diagram illustrating a state in which a drone measures a temperature while moving in a measurement target area.

FIG. 3 is a functional block diagram illustrating an example of a configuration of an information processing device included in a measurement system.

FIG. 4 is a flowchart illustrating an example of a measurement method using a measurement system.

FIG. 5 is a diagram illustrating an example of a hardware configuration of an information processing device.

### DESCRIPTION OF EMBODIMENTS

An embodiment of the present invention will be described below with reference to the drawings.

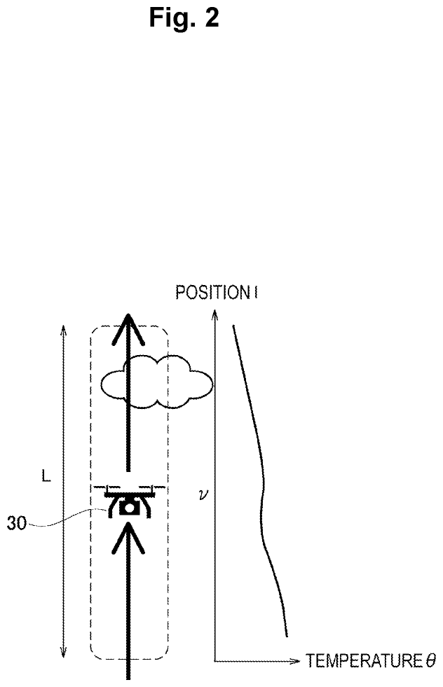

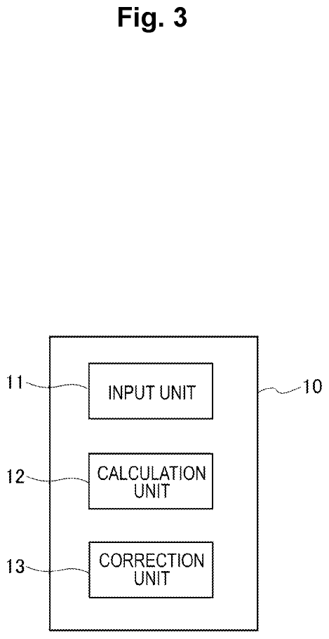

As illustrated in FIG. 2, a measurement system according to the present embodiment is a measurement system that measures the temperature of a measurement target area in the vertical direction using a sensor mounted on a drone 30. The measurement system includes the drone 30 and an information processing device 10 illustrated in FIG. 3. The information processing device 10 obtains a time constant of the sensor mounted on the drone 30 from the results of two measurements made by the drone 30, and corrects the measured value using the time constant of the sensor. Note that the measurement target area and the temperature are just examples, the measurement target area is not limited to the vertical direction, and the physical quantity to be measured is not limited to the temperature. In addition to the drone 30, it can be used with any moving object that can be equipped with a sensor, regardless of whether it is manned or unmanned.

The information processing device 10 illustrated in FIG. 3 includes an input unit 11, a calculation unit 12, and a correction unit 13.

A measurement result of the measurement target area is input to the input unit 11. More specifically, two measurement results obtained by the drone 30 measuring the measurement target area in two flights at different velocities and the velocities of each of the two flights are input to the input unit 11. The measurement results are time-series measurement values of the atmospheric distribution in the measurement target area measured by the sensor. The input unit 11 may sequentially receive the measured values wirelessly during the flight of the drone 30, or the drone 30 may hold the measured values and input the measured values after two measurements by the drone 30.

The calculation unit 12 obtains the time constant of the sensor from the two measurement results and the ratio between the velocities of the two flights. Details of how to obtain the time constant will be described later.

The correction unit 13 corrects the measured value using the time constant obtained by the calculation unit 12. After the time constant is obtained, the moving velocity of the drone 30 is increased to measure the atmospheric distribution in the measurement target area, and the correction unit 13 corrects the measured value using the time constant.

Note that the information processing device 10 may be mounted on the drone 30 or may be configured as a device different from the drone 30.

Here, derivation of the time constant of the sensor mounted on the drone 30 will be described.

In the first measurement, the drone 30 measures the temperature while moving from a start point to an end point within the measurement target area at a constant velocity v₁. A true value of the atmospheric distribution at this time is defined as x₁(t), and a time-series measurement value of the atmospheric distribution obtained by the sensor is defined as y₁(t). t is a time that has elapsed since the drone 30 entered the measurement target area and started the measurement. It is assumed that the drone 30 exists at the start point within the measurement target area when t=0.

In the second measurement, the drone 30 measures the temperature while ascending along the same route as the first measurement at a constant velocity v₂ different from the velocity v₁ during the first measurement. A true value of the atmospheric distribution at this time is defined as x₂(t), and a time-series measurement value of the atmospheric distribution obtained by the sensor is defined as y₂(t).

The first and second measurements are performed at short intervals, and the true value of the atmospheric distribution is assumed to remain unchanged as θ(l) in both cases. l is a distance from the start point within the measurement target area. If the distance from the start point to the end point is L, then 0<l<L. θ(v₁t)=x₁(t), θ(v₂t)=x₂(t), and x₂(t)=x₁(at), a=v₂/v₁.

Hereinafter, the Laplace transform of the first and second true values x₁(t) and x₂(t) and the measured values y₁(t) and y₂(t) will be expressed as follows.

$$\begin{matrix}[ {x}_{1} ( t ) ] = {X}_{1} ( s ) , \\ [ {x}_{2} ( t ) ] = {X}_{2} ( s ) , \\ [ {y}_{1} ( t ) ] = {Y}_{1} ( s ) , \\ [ {y}_{2} ( t ) ] = {Y}_{2} ( s )\end{matrix} \qquad [ Math . 1 ]$$

A transfer function H(s) of the sensor response, which has a time constant τ, can be expressed as shown in Equation (1).

$$\begin{matrix}[ Math . 2 ] & \\ H ( s ) = \frac{1}{τ s + 1} & ( 1 )\end{matrix}$$

Equations (2) and (3) are established for the transfer function H(s) and the Laplace transforms X₁(s), X₂(s), Y₁(s), and Y₂(s).

$$\begin{matrix}[ Math . 3 ] & \\ H ( s ) \cdot {X}_{1} ( s ) = {Y}_{1} ( s ) & ( 2 )\end{matrix}$$

$$H ( s ) \cdot {X}_{2} ( s ) = {Y}_{2} ( s ) \qquad ( 3 )$$

Here, for X₁(s) and X₂(s), since x₂(t)=x₁(at), the relationship in Equation (4) is established.

$$\begin{matrix}[ Math . 4 ] & \\ {X}_{2} ( s ) = [ {x}_{2} ( t ) ] = [ {x}_{1} ( at ) ] = \frac{1}{a} {X}_{1} ( \frac{s}{a} ) & ( 4 )\end{matrix}$$

When Equation (4) is substituted into Equation (3) as in Equation (5), and Equation (6) is obtained.

$$\begin{matrix}[ Math . 5 ] & \\ H ( s ) \cdot \frac{1}{a} {X}_{1} ( \frac{s}{a} ) = {Y}_{2} ( s ) \frac{1}{a} \cdot H ( as ) \cdot {X}_{1} ( s ) = {Y}_{2} ( as ) & ( 5 )\end{matrix}$$

When there is no error, the time constant τ is derived from Equations (1), (2), and (6) as in Equation (7) using the Laplace transforms Y₁(s) and Y₂(s) of the two measured values y₁(t) and y₂(t) and a ratio a between the velocities v₁ and v₂ of two measurements.

$$\begin{matrix}[ Math . 6 ] & \\ τ = ( \frac{( a - 1 ) {Y}_{1} ( s )}{{aY}_{2} ( s ) - {Y}_{1} ( s )} - 1 ) \cdot \frac{1}{a} . & ( 7 )\end{matrix}$$

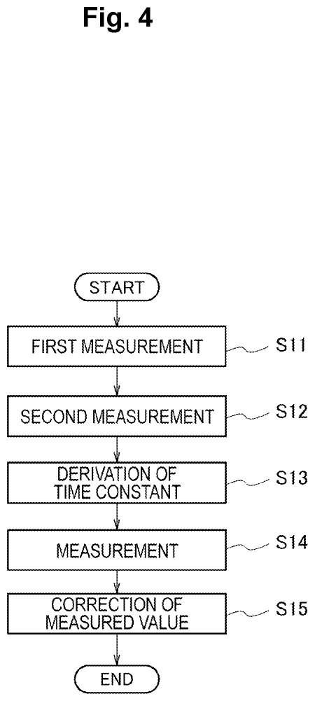

Next, an example of a measurement method of the measurement system according to the present embodiment will be described with reference to the flowchart of FIG. 4.

In step S11, the drone 30 performs the first measurement. For example, the drone 30 always moves within the measurement target area at a velocity v₁=20 m/s to obtain a measured value y₁[n] of the atmospheric distribution. The measured value y₁[n] is a discrete time-series signal.

In step S12, the drone 30 performs the second measurement at a velocity different from that in the first measurement. For example, the drone 30 always moves within the measurement target area at a velocity v₂=5 m/s to obtain a measured value y₂[n] of the atmospheric distribution. The measured value y₂[n] is a discrete time-series signal.

In step S13, the information processing device 10 receives the first and second measured values y₁[n] and y₂[n] and the first and second velocities v₁ and v₂ from the drone 30, and obtains the time constant τ of the sensor using Equation (7). Note that, since the measured values y₁[n] and y₂[n] are discrete time-series signals, Y₁[z] and Y₂[z] obtained by z-transforming the measured values y₁[n] and y₂[n] using the following equation are used.

$$Y ( z ) = {\sum }_{n = 0}^{N - 1} y [ n ] {z}^{- n} \qquad [ Math . 7 ]$$

Here, N is the number of samples of the measured values y₁[n] and y₂[n].

The time constant τ can be derived by obtaining τ that minimizes the following J using the least squares method.

$$\begin{matrix}J = {( {\sum }_{z = 0}^{N - 1} f [ z ] - τ )}^{2} , \\ f [ z ] = ( \frac{( a - 1 ) {Y}_{1} [ z ]}{a {Y}_{2} [ z ] - {Y}_{1} [ z ]} - 1 ) \cdot \frac{1}{a} , a = \frac{{v}_{2}}{{v}_{1}}\end{matrix} \qquad [ Math . 8 ]$$

After deriving the time constant τ of the sensor, in step S14, the drone 30 increases the moving velocity to measure the measurement target area, and in step S15, the information processing device 10 corrects the measured value using the derived time constant τ.

In the present embodiment, the time constant is obtained by performing the measurement twice in the measurement target area before the actual measurement, but the time constant may be obtained in advance by performing the measurement twice in another place.

As described above, according to the present embodiment, the drone 30 equipped with a sensor obtains the measured value y₁(t) while moving at the velocity v₁, the drone 30 obtains the measured value y₂(t) while moving at the velocity v₂ different from the velocity v₁, and the information processing device 10 derives a time constant τ of the sensor for correcting the measured value of the sensor using the measured values y₁(t) and y₂(t) and the velocities v₁ and v₂ for a transfer function of the sensor. Accordingly, the time constant of the sensor can be accurately obtained, and even if the velocity of the drone 30 is increased and the measurement is performed, the measured value is corrected using the obtained time constant, whereby highly accurate measurement can be achieved. That is, by using the measurement system according to the present embodiment, it is possible to achieve measurement with high accuracy and high simultaneity.

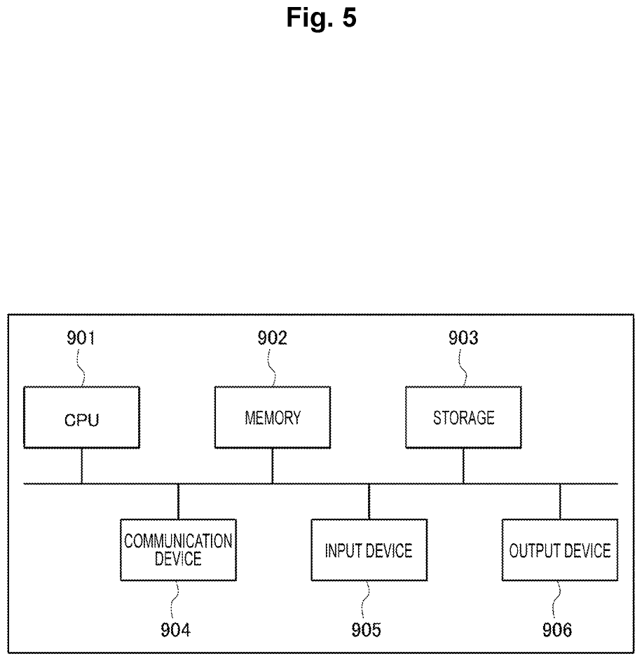

For example, as illustrated in FIG. 5, a general-purpose computer system including a central processing unit (CPU) 901, a memory 902, a storage 903, a communication device 904, an input device 905, and an output device 906 can be used as the information processing device 10 described above. In this computer system, the CPU 901 executes a predetermined program loaded on the memory 902, thereby implementing the information processing device 10. This program can be recorded on a computer-readable recording medium such as a magnetic disk, an optical disc, or a semiconductor memory, or can be distributed via a network.

### REFERENCE SIGNS LIST

10 Information processing device
11 Input unit
12 Calculation unit
13 Correction unit
30 Drone

1. A measurement method using a moving object equipped with a sensor, the measurement method comprising:
obtaining a first measured value while the moving object is moving at a first velocity;
obtaining a second measured value while the moving object is moving at a second velocity different from the first velocity; and
deriving a time constant of the sensor for correcting the measured value of the sensor using the first measured value, the second measured value, the first velocity, and the second velocity for a transfer function of the sensor.

2. The measurement method according to claim 1, wherein the time constant of the sensor is derived using the following equation,
$$τ = ( \frac{( a - 1 ) {Y}_{1} ( s )}{{aY}_{2} ( s ) - {Y}_{1} ( s )} - 1 ) \cdot \frac{1}{a} \underline{.}$$
where Y₁(s) is a Laplace transform of the first measured value, Y₂(s) is a Laplace transform of the second measured value, and a is a ratio of the second velocity to the first velocity.

3. The measurement method according to claim 1, wherein
the first measured value and the second measured value are discrete time-series signals, and
the time constant of the sensor that minimizes the following equations is derived using the least squares method,
$$\begin{matrix}J = {( {\sum }_{z = 0}^{N - 1} f [ z ] - τ )}^{2} , \\ f [ z ] = ( \frac{( a - 1 ) {Y}_{1} [ z ]}{a {Y}_{2} [ z ] - {Y}_{1} [ z ]} - 1 ) \cdot \frac{1}{a} , a = \frac{{v}_{2}}{{v}_{1}}\end{matrix} \underline{.}$$
where Y₁[z] is a z-transform of the first measured value, Y₂[z] is a z-transform of the second measured value, and a is a ratio of the second velocity to the first velocity.

4. A measurement system comprising:
a moving object equipped with a sensor; and
an information processing device configured to derive a time constant of the sensor, wherein
the moving object is configured to obtain a first measured value while moving at a first velocity, and obtain a second measured value while moving at a second velocity different from the first velocity, and
the information processing device includes:
an input unit to which the first measured value, the second measured value, the first velocity, and the second velocity are configured to be input; and
a calculation unit configured to derive a time constant of the sensor for correcting the measured value of the sensor using the first measured value, the second measured value, the first velocity, and the second velocity for a transfer function of the sensor.

5. An information processing device configured to derive a time constant of a sensor mounted on a moving object, the information processing device comprising:
an input unit to which a first measured value obtained while the moving object is moving at a first velocity, a second measured value obtained while the moving object is moving at a second velocity different from the first velocity, the first velocity and the second velocity are configured to be input; and
a calculation unit configured to derive a time constant of the sensor for correcting the measured value of the sensor using the first measured value, the second measured value, the first velocity, and the second velocity for a transfer function of the sensor.
